(19) United States
(12) Patent Application Publication
(10) Pub. No.: US 2008/0027175 A1
(43) Pub. Date: Jan. 31, 2008

(54) Novel Poly(Vinylester) Copolymers and Poly (Vinylalcohol) Copolymers and the Use Thereof

(75) Inventors: Monika Bruckmann, Frankfurt am Main (DE); Tim Dickner, Frankfurt am Main (DE); Joerg Schottek, Frankfurt am Main (DE); Joerg Ludwig Schulte, Frankfurt am Main (DE); Uwe Blank, Wiesbaden (DE)

Correspondence Address: CONNOLLY BOVE LODGE & HUTZ, LLP, P O BOX 2207, WILMINGTON, DE, 19899, US

(73) Assignee: Celanese Ventures GmbH, Frankfurt am Main (DE)

(21) Appl. No.: 10/581,841

(22) PCT Filed: Dec. 3, 2004
(86) PCT No.: PCT/EP04/13767

§ 371 Date: Apr. 12, 2007

(51) Int. Cl. C08F 218/04; C08F 216/02; C08F 263/02; C08F 293/00; C08F 8/12

(52) U.S. Cl. 525/57

(57) ABSTRACT

The present invention relates to novel polymers, which are based on poly(vinyl ester) copolymers and poly(vinyl alcohol) copolymers having excellent thermal properties because of their special composition and to the use of said polymers.

The poly(vinyl alcohol-polyalkene) copolymers and polymer mixtures obtained in this way are characterized by a strongly modified melting behavior compared to linear poly(vinyl alcohols).

The present invention relates to novel polymers which are based on poly(vinyl ester) copolymers and poly(vinyl alcohol) copolymers having excellent thermal properties because of their special composition and to the use of said polymers. Poly(vinyl ester)s are polymers which are obtainable from vinyl esters having the group

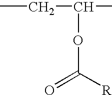

as the basic building block of the macromolecules. Among these, the poly(vinyl acetates) (R═CH3) have by far the greatest technical significance.

Poly(vinyl acetate) is an important thermoplastic polymer and is used, among others, as an adhesive (component), lacquer raw material, for packaging films, for the coating of paper and foodstuffs (sausage and cheese coatings), as an additive for concrete and as a raw material for the preparation of poly(vinyl alcohol)s and poly(vinyl acetal)s (Römpp Lexikon Chemie—Version 2.0, Stuttgart/New York: Georg Thieme Verlag 1999).

Commercially available poly(vinyl acetate) comprises more or less linear polymers which are prepared by free radical polymerization of vinyl acetate and the polymerization may be carried out in solution, in bulk and in emulsion. The free radical initiators used are for example, azoisobutyronitrile (AIBN) and dibenzoyl peroxide (BPO) With this type of reaction strategy, the synthesis of block copolymers having a defined composition (molecular weight and molecular weight distribution) and of polymers having a high degree of branching and, at the same time, narrow molecular weight distribution is possible only with difficulty.

Poly(vinyl alcohol)s can be technically prepared by saponification of poly(vinyl acetate)s. The group

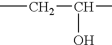

is characterizing as the basic building block of the macromolecules. Commercially available poly(vinyl alcohol)s can have different degrees of hydrolysis, i.e. still contain a residual amount of acetyl groups. These polymers may be understood as poly(vinyl alcohol)-poly(vinyl acetate) copolymers. Poly(vinyl alcohol)s are used primarily in the following application areas: as protective colloid, emulsifier, binding agent, for protective coatings and adhesives, finishing agents, sizing agents, metal protection coatings, for the production of ointments and emulsions, water-soluble bags and packaging films, oil-, fat- and fuel-resistant hoses and seals, as shaving cream and soap additive, thickening agents in pharmaceutical and cosmetic preparations, as synthetic tear fluid. Poly(vinyl alcohol) may be spun into water-soluble fibers, so-called vinal fibers, or foamed up into sponges. As reactive polymers, which may be chemically broadly diversified (acetalized, esterified, etherified or cross-linked) through the secondary hydroxy groups, poly(vinyl alcohol)s serve as raw materials for the production of, for example, poly(vinyl acetal)s (e.g. poly(vinyl butyral)s) (Römpp Lexikon Chemie—Version 2.0, Stuttgart/New York: Georg Thieme Verlag 1999).

A possible means of controlling the radical polymerization of vinyl acetate consists in the addition of tertiary alkyl esters of phosphorous acid. The control is herein achieved by reversible reaction of the polymer radical with the tertiary alkyl ester of phosphorous acid. The resulting phosphorous radical is slow to react in comparison with the polymer radical. New monomers can be built in by reverse reaction, i.e. formation of the reactive polymer radical. Defined polymers having narrow molecular weight distributions and a defined molecular weight are obtained (K. Matyjaszewski et al. J. Macromol. Sci.—Pure Appl. Chem., 1994, A31(11), 1561-1578.). The advantage of such living polymerization is that it is possible to provide block copolymers of defined composition. Star-shaped structures may be created by cross-linking using poly alkenes as comonomer. T. Tsoukatos, for example, has identified star-shaped structures in the copolymerization of styrene with divinylbenzene by means of nitroxide mediated radical polymerization (T. Tsoukatos, et al. J. Polym. Sci., Polym. Chem., 2001, 39, 320.).

Poly(vinyl ester)s having special, for example, star-like geometries and a narrow molecular weight distribution have so far only been described in DE 10238659. The synthesis is possible through so-called “ATRP” (Atom Transfer Radical Polymerization) of vinyl esters, i.e. a controlled radical polymerization carried out under metal catalysis. The star structure and the number of polymer chains of the star-shaped poly(vinyl ester)s prepared by means of ATRP according to DE10238659 is determined and limited by the initiator used. Moreover, the synthesis of the individual initiators is complicated. A further disadvantage of this method is the purification required to remove undesirable metal residues from the polymers.

Owing to these disadvantages, i.e. the complex synthesis of initiators, the associated limitation of the number of arms of the star-shaped poly(vinyl ester), as well as the necessary purification, the preparation of, for example, poly(vinyl acetate) having a special geometry, such as for example star-shaped or hyper-branched poly(vinyl acetate) comprising a large number of poly(vinyl acetate) arms (nₐᵣₘ>12) and a narrow molecular weight distribution, constitutes a challenge.

The synthesis of new poly(vinyl alcohol)s having, for example, a star-shaped structure, also constitutes a challenge. New properties are to be expected, thus should, for example, the melting point decrease with the decomposition point remaining unchanged, which may result, as the case may be, in new application areas, such as, for example, extrudable poly(vinyl alcohol). So far, poly(vinyl alcohol) can only be extruded by adding plasticizers, which, however, deteriorates the barrier properties in relation to oxygen, for example.

Star-shaped polymers which are based on other monomers find uses, for example, in the production of fibers, films and moldings, as gel formers, as a rubber, for the controlled release of active ingredients, as liquid crystals and as high-performance plastics for microelectronic materials.

It is thus the object of the present invention to develop a novel method for preparing poly(vinyl ester)s, which avoids the described disadvantage of the prior art and leads to new novel polymers.

It has now been found that, surprisingly, the synthesis of novel poly(vinyl ester)s and the reaction products obtainable therefrom, such as, for example, poly(vinyl alcohol)s, with special geometries is possible by means of a controlled radical copolymerization using tertiary alkyl esters of phosphorous acid, alkyl halides or arylalkyl halides, or alkyl aromatic compounds as control reagent (radical scavenger) and polyalkenyl comonomers.

Object of the present invention are poly(vinyl alcohol) copolymers on the basis of poly(vinyl ester) copolymers which are obtained by means of a method comprising the following steps:
A) Radical solution or bulk polymerization of vinyl esters in the presence of a radical generator and in the presence of a radical scavenger.
B) Addition of a cross-linking polyalkenyl compound,
C) if necessary, processing and isolation of the poly(vinyl ester) copolymers formed,
D) saponification of the poly(vinyl ester)/poly(vinyl ester polyalkene) mixture prepared in step B) or of the poly(vinyl ester-polyalkene) copolymers isolated under step C) with a base, preferably methanolic NaOH, to poly(vinyl alcohol)/poly(vinyl alcohol-polyalkene) mixtures or poly(vinyl alcohol-polyalkene) copolymers, respectively, and isolation of the products.

The radical generators used in step A) according to the invention are peroxide compounds such as, for example, di(4-t-butylcyclohexyl) peroxydicarbonate, t-butylcumyl peroxide, dibenzoyl peroxide, 2,2-di(t-butylperoxy)butane, dicyclohexyl peroxydicarbonate, cumol hydroperoxide, di-t-amyl peroxide, di-t-butyl peroxide, dilauroyl peroxide, disuccinoyl peroxide, t-amyl perbenzoate, t-amyl peroxy-2-ethylhexyl carbonate, t-butyl hydroperoxide, t-butyl peracetate, t-butyl perbenzoate, t-butyl peroxyisopropyl carbonate, t-butyl perneodecanoate, 1,1-di(t-butylperoxy)-3,3,5-trimethylcyclohexane, di-(2-ethylhexyl) peroxydicarbonate and similar compounds; or azo-compounds, such as, for example, α,α′-azobisisobutyronitrile and similar compounds.

Preferably used radical generators are dibenzoyl peroxide, t-butyl perneodecanoate, di-(2-ethylhexyl) peroxydicarbonate and α,α′-azobisisobutyronitrile.

The radical generators may be used individually or as a mixture of two or more. Moreover, they are used in amounts of 0.05-10 mmol, preferably 0.5-5 mmol, particularly preferably 1-3 mmol per mole of vinyl acetate.

The radical scavengers used in step A) according to the invention are preferably phosphoric acid esters, in particular trimethyl phosphite, dimethyl phosphite, triethyl phosphite, diethyl phosphite, triisopropyl phosphite, tri-n-butyl phosphite, triphenyl phosphite, diphenyl isodecyl phosphite, phenyl diisodecyl phosphite, triisodecyl phosphite, diphenyl isooctyl phosphite, phenyl diisooctyl phosphite, triisooctyl phosphite, dinonylphenyl bis(nonylphenyl) phosphite, tris(nonylphenyl) phosphite, distearyl pentaerythritol diphosphite, diisodecyl pentaerythritol diphosphite, tris(2,2,2-trifluorethyl) phosphite and similar compounds. Preferably used phosphoric acid esters are trimethyl phosphite, triethyl phosphite, tris(2,2,2-trifluorethyl) phosphite, particular preferred is tris(2,2,2-trifluorethyl) phosphite.

The phosphoric acid esters employed may be used individually or as a mixture of two or several. Moreover, they are used in amounts of 0.5-10 mol, preferably 1-5 mol, particularly preferably 2-4 mol per mole of radical initiator.

Further radical scavengers in step A) according to the invention are, for example, alkyl halides such as iodomethane, ethyl iodide, n-propyl iodide, isopropyl iodide, pentaerythrityl tetral iodide, or arylalkyl halides such as benzyl iodide. Particularly preferred is ethyl iodide or benzyl iodide. The alkyl halides or arylalkyl halides employed may be used individually or as a mixture of two or several. Moreover, they are used in amounts of 0.5-10 mol, preferably 1-5 mol, particularly preferably 2-4 mol per mole of radical initiator.

Further radical scavengers in step A) according to the invention are, for example, alkyl aromatic compounds such as toluene, dimethylbenzene, ethylbenzene, n-propylbenzene, isopropylbenzene or xylene. Particularly preferred is toluene. The alkyl aromatic compounds employed may be used individually or as a mixture of two or several. Moreover, they are used in amounts of 0.5-10 mol, preferably 1-5 mol, particularly preferably 2-4 mol per mole of radical initiator.

In addition, any mixtures comprising the three classes of radical scavengers mentioned above may be used.

The chain length of the poly(vinyl ester) prepared in step A) may be determined by the reaction parameters (time, temperature, pressure, concentrations). It comprises between 3 and 100 000, preferably 5 to 10 000, particularly preferably 10 to 1500 monomer units.

The polyalkenyl compounds used in step B) according to the invention are compounds of the formula I:

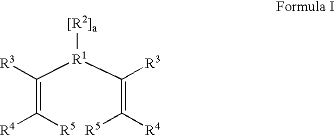

where:

R¹ is a C₆-C₂₀-aryl group, a C₅-C₂₀-heteroaryl group, a C₄-C₂₀-cycloalkyl group, a C₄-C₂₀-heterocycloalkyl group or a C₁-C₂₀- alkyl group, in which one or several not directly neighboring C-atoms may be substituted by an element of the 5. or 6. group of elements, preferably nitrogen, phosphorous, oxygen or sulfur, particularly preferably nitrogen or oxygen, and

R² is equal or different, and is hydrogen, oxygen, sulfur or a hydroxy group, a carbamoyl group, an amino group, a carboxy group, a C₁-C₂₀-alkylcarbonyl group, a C₁-C₂₀-alkyloxy group, a C₆-C₂₀-aryloxy group, an imino group, a C₁-C₂₀-alkylimino group, a C₆-C₂₀-alkylimino group, a cyano group, a C₁-C₂₀-alkyl group, a C₆-C₂₀-aryl group, a C₅-C₂₀-heteroaryl group, a C₄-C₂₀-cycloalkyl group, a C₄-C₂₀-heterocycloalkyl a C₇-C₂₀-alkylaryl group, a C₇-C₃₀-arylalkyl group, a C₂-C₂₀-alkenyl group, a C₂-C₂₀-α-oxyalkenyl, a halogen containing C₁-C₂₀-alkyl group, a C₆-C₂₀-aryl group, a C₇-C₂₀-alkylaryl group, a C₇-C₃₀-arylalkyl group or a C₂-C₂₀-alkenyl group, and

R³, R⁴, R⁵ are equal or different, and is hydrogen or a C₁-C₂₀-carbon containing group, and

a is a natural integer from 0 to 40.

In the context of the present invention, a C₁-C₂₀-carbon containing group refers preferably to the groups C₁-C₂₀-alkyl, particularly preferably methyl, ethyl, n-propyl, i-propyl, n-butyl, i-butyl, s-butyl, t-butyl, n-pentyl, s-pentyl, cyclopentyl, n-hexyl, cyclohexyl, n-octyl or cyclooctyl, C₁-C₂₀-alkenyl, particularly preferably ethenyl, propenyl, butenyl, pentenyl, cyclopentenyl, hexenyl, cyclohexenyl, octenyl or cyclooctenyl, C₆-C₂₀-aryl, particularly preferably phenyl, biphenyl, naphthyl or anthracenyl, triphenylenyl, [1,1′;3′,1″]terphenyl-2′-yl, binaphthyl or phenanthrenyl, halogen containing C₁-C₂₀-alkyl, particularly preferably trifluormethyl, pentafluorethyl or 2,2,2-trifluorethyl, halogen containing C₆-C₂₀-fluoraryl, particularly preferably tetrafluorophenyl or heptafluoronaphthyl, C₁-C₂₀-alkoxy, particularly preferably methoxy, ethoxy, n-propoxy, i-propoxy, n-butoxy, i-butoxy, s-butoxy or t-butoxy, C₆-C₂₀-aryloxy, particularly preferably phenoxy, naphthoxy, biphenyloxy, anthracenyloxy, phenanthrenyloxy, C₇-C₂₀-arylalkyl, particularly preferably o-tolyl, m-tolyl, p-tolyl, 2,6-dimethylphenyl, 2,6-diethylphenyl, 2,6-di-i-propylphenyl, 2,6-di-t-butylphenyl, o-t-butylphenyl, m-t-butylphenyl, p-t-butylphenyl, C₇-C₂₀-alkylaryl, particularly preferably benzyl, ethylphenyl, propylphenyl, diphenylmethyl, triphenylmethyl or naphthalenyl methyl, C₅-C₂₀-heteroaryl, particularly preferably 2-pyridyl, 3-pyridyl, 4-pyridyl, quinolinyl, isoquinolinyl, acridinyl, benzoquinolinyl or benzoisoquinolinyl, C₄-C₂₀-heterocycloalkyl, particularly preferably furyl, benzofuryl, 2-pyrolidinyl, 2-indolyl, 3-indolyl, 2,3-dihydroindolyl, C₈-C₂₀-arylalkenyl, particularly preferably o-vinylphenyl, m-vinylphenyl, p-vinylphenyl, wherein one or more C₁-C₂₀-carbon containing groups may form a cyclic system.

Illustrative examples of compounds of the formula I, which do not, however, restrict the invention, are:

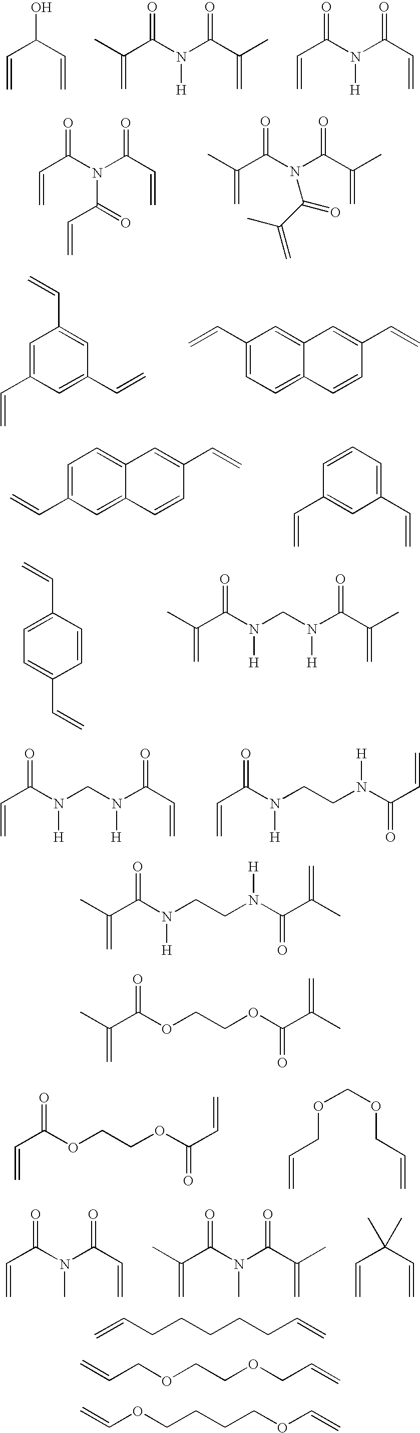

The poly(vinyl ester-polyalkenyl) copolymer formed in step B) recurring units of the general formula II and/or returning units of the general formula III by cross-linking of the poly(polyalkenyl) groups:

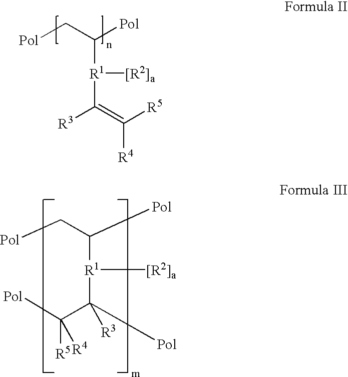

where

Pol stands for a polymer on the basis of a poly(vinyl ester) and/or a poly(vinyl ester-polyalkenyl) copolymer and/or a poly(polyalkenyl), wherein the poly(polyalkenyl) block may, in turn, comprise recurring units of the general formula (I) and/or the formula (II), and

R¹, R², R³, R⁴, R⁵ have the same meaning as described above, and

a has the same meaning as described above, and

n, m is a natural integer larger/smaller than 1.

Preferably, step B) is a block copolymerization.

The polyalkenyl compounds employed in step B) may be used individually or as a mixture of two or several. Moreover, they are used in amounts of 0.0005-1 mol, preferably 0.001-0.2 mol, particularly preferably 0.005-0.2 mol per mole of vinyl acetate.

The polymerization in steps A) and B) is carried out at a temperature of from 0 to 300° C., preferably from 50 to 200° C., even more particularly preferably 50-80° C. The pressure is from 0.5 to 2000 bar, preferably from 1 to 64 bar. The polymerization may be carried out in solution, in bulk, continuously or discontinuously, in one or several steps. Suitable solvents for the polymerization are, for example, ethers, such as diethyl ether, dibutyl ether, methyl t-butyl ether, tetrahydrofuran, dioxane, anisole, diphenyl ether, ethylphenyl ether, aliphatic hydrocarbons such as pentane, hexane and suchlike or aromatic hydrocarbons such as benzene, toluene, xylols and suchlike, as well as ethyl acetate, acetone, N,N-dimethylformamide, ethylene carbonate, methanol, ethanol, propanol, i-propanol or water. According to the invention, mixtures of different solvents in different quantitative ratios my also be employed.

The composition of the poly(vinyl ester-polyalkenyl) copolymers, i.e. the number of poly(vinyl ester) chains per copolymer molecule cross-linked by means of the poly(polyalkenyl) block, and/or the residual content of poly(vinyl ester) in the polymer mixture obtained may be determined by the reaction parameters (time, temperature, pressure, concentrations) set in step B) and/or the kind of reaction strategy (continuous, discontinuous, in one or several steps).

The number of polyvinyl chains per copolymer molecule may be from 3 to 1000, preferably from 10 to 400, particularly preferably from 13 to 100.

Processing/isolation of the poly(vinyl ester-polyalkene) copolymers from the polymer mixture as described in step C) can take place by means of preparative GPC or by reprecipitation or fractionated precipitation of the polymers. Suitable solvents for the polymer mixture are toluene, benzene or xylene, acetone, diethyl ketone or methyl isobutyl ketone, tetrahydrofuran, anisole or dioxane, methyl acetate, ethyl acetate or butyl acetate, methanol or ethanol, dichloromethane or trichloromethane, as well as ethylene carbonate or N,N-dimethylformamide or dimethylsulfoxide. According to the invention, mixtures of different solvents in different quantitative ratios my also be employed. Suitable non-solvents are, for example, pentane, hexane, heptane and the like, as well as water, diethyl ether, dibutyl ether, methyl-t-butyl ether, propanol or isopropanol. The ratio of solvent to non-solvent may be between 0.01 and 2. Preferred is a ratio of 0.05 to 1, particularly preferred a ratio of 0.08 to 0.9.

The polymer mixtures prepared in step B) and/or the copolymers isolated in step C) are particularly well suited as painting agent, adhesives, finishing agent, coating agent, as additives for concrete and in papermaking as adhesive (component), as lacquer component and as high-performance plastics.

The method according to step D) for saponifying the polymer mixture prepared in step B) or the poly(vinyl ester-polyalkenyl) copolymer isolated in step C), comprises the following steps:
E) Dissolving the polymer mixture from step B) or the poly(vinyl ester-polyalkenyl) copolymer from step C) in one or several organic solvents,
F) dropwise adding the solution from E) to a solution of an acid or a solution of a base in one or several aqueous or one or several organic solvent(s), with heating and stirring, if necessary,
G) reacting the mixture from F) for a determined period of time, with heating and stirring, if necessary,
H) isolating the polymer by filtration or centrifugation of the mixture from G),
I) washing the polymer with an organic solvent, and
K) drying the polymer.

The solvents used in step E) and F) are preferably (i) aromatic hydrocarbons, in particular toluene, benzene or xylene, (ii) ketones, in particular acetone, diethyl ketone or methyl isobutyl ketone, (iii) ethers, in particular diethyl ether, dibutyl ether, methyl t-butyl ether, tetrahydrofuran, anisole or dioxane, (iv) esters, in particular methyl acetate or ethyl acetate, (v) alcohols, in particular methanol, ethanol or isopropanol, (vi) halogenated hydrocarbons, in particular dichloromethane or trichloromethane, as well as (vii) ethylene carbonate or (viii) N,N-dimethylformamide.

The acids used in step F) are preferably inorganic and/or organic acids, in particular hydrogen fluoride, hydrochloric acid, hydrogen bromide, hydrogen iodide, phosphoric acid, phosphorous acid, hypophosphorous acid, sulfuric acid, sulfurous acid, acetic acid, tartaric acid, nitric acid, nitrous acid, ammonium chloride or citric acid. The bases used in step M) are preferably inorganic and/or organic bases, in particular sodium hydroxide, potassium hydroxide, sodium methoxide, sodium ethoxide, sodium propoxide, sodium isopropoxide, sodium butoxide, potassium methoxide, potassium ethoxide, potassium propoxide, potassium isopropoxide, potassium butoxide, magnesium hydroxide, calcium hydroxide, ammonia, tetramethylethylenediamine, trimethylamine, triethylamine, EDTA sodium salt or hexamethylenetetramine. The solvents used in step E) are preferably (i) aromatic hydrocarbons, in particular toluene, benzene or xylene, (ii) ketones, in particular acetone, diethyl ketone or methyl isobutyl ketone, (iii) ethers, in particular diethyl ether, dibutyl ether, methyl t-butyl ether, tetrahydrofuran, anisole or dioxane, (iv) esters, in particular such as methyl acetate or ethyl acetate, (v) alcohols, in particular methanol, ethanol or isopropanol, (vi) halogenated hydrocarbons, in particular dichloromethane or trichloromethane, (vii) ethylene carbonate or (viii) N,N-dimethylformamide, as well as water.

The degree of saponification of the polyvinyl chains of both the homopoly(vinyl ester) and the poly(vinyl ester-polyalkenyl) copolymer may be adjusted through the reaction time in step G). A shorter reaction time leads to a lower degree of saponification, while a longer reaction time leads to a complete saponification.

A preferred embodiment of the process according to the invention comprises the dissolution of the polymer mixture from step B) or of the poly(vinyl ester-polyalkenyl) copolymer from step C) as per step E) in methanol and/or acetone, dropwise addition of the solution to a methanolic or aqueous solution of an inorganic base as per step F), reaction of the mixture from F) at elevated temperature as per step G) for a determined period of time, filtration of the suspension as per step H) and washing of the polymer with methanol and/or acetone as per step I) and drying of the polymer as per step K).

A particularly preferred embodiment of the process according to the invention comprises the dissolution of the polymer mixture from step B) or of the poly(vinyl ester-polyalkenyl) copolymer from step C) as per step E) in methanol, dropwise addition of the solution to a methanolic of sodium hydroxide (1% NaOH in methanol) as per step F), reaction of the mixture from F) at 50° C. as per step G) for one hour, filtration of the suspension as per step H) and washing of the polymer with methanol as per step I) and drying of the polymer as per step K).

The saponification of the poly(vinyl ester-polyalkenyl) copolymers can be carried out either discontinuously or continuously according to EP 0 942 008. An additive may optionally be added during the saponification, said additive preventing a yellow coloration of the poly(vinyl alcohol) or poly(vinyl alcohol-polyalkene) copolymer. Examples for such additives are described in U.S. Pat. No. 2,862,916, GB808,108 and U.S. Pat. No. 6,046,272.

The poly(vinyl alcohol-polyalkene) copolymers and polymer mixtures obtained in this way are characterized by a strongly modified melting behavior compared to linear poly(vinyl alcohol)s. Thus, linear PVOH (Celvol 103 98% hydrolyzed) melts at 194° C. (onset), the polymer mixture: poly(vinyl alcohol-divinylbenzene)/poly(vinyl alcohol) from example 7 melts at 183° C. (onset), the isolated copolymer: poly(vinyl alcohol-divinylbenzene) from example 8, in contrast, does no longer present a melting point.

A further object of the invention is the use of the poly(vinyl alcohol-polyalkenyl) copolymers according to the invention as well as the polymer mixtures comprising poly(vinyl alcohol-polyalkenyl) copolymers and poly(vinyl alcohol) as protective colloid, emulsifier, binding agent, for protective coatings and adhesives, finishing agents, sizing agents, metal protection coatings, for the production of ointments and emulsions, water-soluble bags and packaging films, oil-, fat- and fuel-resistant films, hoses and seals, as shaving cream and soap additive, thickening agents in pharmaceutical and cosmetic preparations, as synthetic tear fluid, water-soluble fibers or sponges, films, cement additive, hydrogels for water treatment and as poly(vinyl alcohol) which can be processed in melted form.

In the following the invention will be described by means of examples which do not, however, restrict the invention.

General comments: The organometallic compounds were prepared and handled with exclusion of air and moisture under argon protective gas (Schlenk technology or glovebox). All solvents required were purged with argon and rendered absolute over molecular sieve.

### EXAMPLE 1

### Poly(vinyl acetate-bis(allyloxy)methane)/poly(vinyl acetate)

A 50 ml Schlenk tube with stirrer bar is initially charged with 3.4 ml of toluene. 6.6 ml (71 mmol) of vinyl acetate, 0.08 ml (0.36 mmol) of tris(2,2,2-trifluorethyl) phosphite and 62.3 mg (0.18 mmol) of dibenzoyl peroxide are added successively at 60° C. The reaction mixture is subsequently stirred in the closed Schlenk tube at 70° C. for 2 h. 0.45 g (3.56 mmol) of bis(allyloxy)methane are added to the reaction mixture and then stirred at 70° C. for 20 h. All volatile components are removed in an oil-pump vacuum. The polymer is dissolved in acetone, precipitated with heptane and dried under vacuum to obtain a white powder. Yield: 1.78 g (27%). ¹H-NMR (500 MHz, CDCl₃): δ=5.89 (t), 5.45 (s), 5.23 (d) poly(bis(allyloxy)methane)), 4.83 (s, br, PVAc), 3.3 (s, br, poly(bis(allyloxy)methane)), 2.13, 1.98, 1.82, 1.72 (4×s, br, PVAc) ppm.

### EXAMPLE 2

### Poly(vinyl acetate-bis(N-acryloylamino)methane)/poly(vinyl acetate)

A 50 ml Schlenk tube with stirrer bar is initially charged with 3.4 ml of methanol. 6.6 ml (71 mmol) of vinyl acetate, 0.08 ml (0.36 mmol) of tris(2,2,2-trifluorethyl) phosphite and 62.3 mg (0.18 mmol) of dibenzoyl peroxide are added successively at 60° C. The reaction mixture is subsequently stirred in the closed Schlenk tube at 70° C. for 2 h. Then, 0.55 g (3.56 mmol) of bis(N-acryloylamino)methane are added to the reaction mixture and stirred at 70° C. for 20 h. All volatile components are removed in an oil-pump vacuum. The polymer is dissolved in acetone, precipitated with heptane and dried under vacuum to obtain a white powder. Yield: 6.6 g (98%). ¹H-NMR (500 MHz, CDCl₃): δ=8.74 (s), 6.48, 6.17, 5.71 (3×dd), 4.87 (s, poly(bis(N-acryloylamino)methane)), 4.83 (s, br, PVAc), 2.42 (s, br, poly(bis(N-acryloylamino)methane)), 2.13, 1.98, 1.82, 1.72 (4×s, br, PVAC) 1.53, (s, br, poly(bis(N-acryloylamino)methane)) ppm.

### EXAMPLE 3

### Poly(vinyl acetate-divinylbenzene)/poly(vinyl acetate)

A 50 ml Schlenk tube with stirrer bar is initially charged with 3.4 ml of methanol. 6.6 ml (71 mmol) of vinyl acetate, 0.08 ml (0.36 mmol) of tris(2,2,2-trifluorethyl) phosphite and 62.3 mg (0.18 mmol) of dibenzoyl peroxide are added successively at 60° C. The reaction mixture is subsequently stirred in the closed Schlenk tube at 70° C. for 2 h. Then, 0.64 ml (3.56 mmol) of divinylbenzene are added to the reaction mixture and stirred at 70° C. for 20 h. All volatile components are removed in an oil-pump vacuum. The polymer is dissolved in acetone, precipitated with heptane and dried under vacuum to obtain a white powder. Yield: 2.12 g (31.4%). ¹H-NMR (500 MHz, CDCl₃): δ=7.34, 7.25. 7.18, 7.16, 7.05 (aromatic H), 6.63, 5.61, 5.18 (vinylic H), 4.83 (PVAc), 2.76 (cross-linked PDVB), 2.13, 1.98, 1.82, 1.72 (4×s, br, PVAc), 1.58 (cross-linked PDVB) ppm. T_{g}=42° C. M_{w}=123000 g/mol. M_{w}/Mₙ=2.00.

### EXAMPLE 4

### Poly(vinyl acetate-divinylbenzene)

A 50 ml Schlenk tube with stirrer bar is initially charged with 7.5 ml of xylene. 6.6 ml (71 mmol) of vinyl acetate, 0.08 ml (0.36 mmol) of tris(2,2,2-trifluorethyl) phosphite and 62.3 mg (0.18 mmol) of dibenzoyl peroxide are added successively at 60° C. The reaction mixture is subsequently stirred in the closed Schlenk tube at 70° C. for 2 h. Then, 0.64 ml (3.56 mmol) of divinylbenzene are added to the reaction mixture and stirred at 70° C. for 20 h. All volatile components are removed in an oil-pump vacuum. The polymer is dissolved in acetone. Fractionation of the polymer mixture is achieved by means of preparative GPC. The 1^{st} fraction (copolymer) is dried under vacuum to obtain a white powder. Yield: 0.8 g (12%). ¹H-NMR (500 MHz, CDCl₃): δ=7.34, 7.25. 7.18, 7.16, 7.05 (aromatic H), 6.63, 5.61, 5.18 (vinylic H), 4.83 (PVAc), 2.13, 1.98, 1.82, 1.72 (4×s, br, PVAC) ppm. T_{g}=43° C. M_{w}=500,000 g/mol. M_{w}/Mₙ=1.64.

### EXAMPLE 5

### Poly(vinyl alcohol-bis(allyloxy)methane)/poly(vinyl alcohol)

In a 1000 ml round-bottom flask, 167 ml of a 1% methanolic sodium hydroxide solution is heated to 50° C. in a water bath. To this, a solution of 50 g of poly(vinyl acetate-bis(allyloxy)methane)/poly(vinyl acetate) (example 1) in 333 ml of methanol is added dropwise over a period of 30 min. On completion of the addition, the mixture is stirred for 30 min. The white precipitate is filtered, washed to neutrality with methanol and dried under vacuum. Yield: 25.0 g (100%). ¹H-NMR (500 MHz, [D₂]-D₂O): δ=5.89 (t), 5.45 (s), 5.23 (d), 3.3 (s, br, poly(bis(allyloxy)methane)), 4.65, 4.46, 3.89, 3.84, 3.31, 1.44-1.33 (4×s, 1×m, PVOH) ppm. DSC: T_{G}=67° C., Tₘ=180° C.

### EXAMPLE 6

### Poly(vinyl alcohol-bis(N-acryloylamino)methane)/poly(vinyl alcohol)

In a 1000 ml round-bottom flask, 167 ml of a 1% methanolic sodium hydroxide solution is heated to 50° C. in a water bath. To this, a solution of 50 g of poly(vinyl acetate-bis(N-acryloylamino)methane)/poly(vinyl acetate) (example 2) in 333 ml of methanol is added dropwise over a period of 30 min. On completion of the addition, the mixture is stirred for 30 min. The white precipitate is filtered, washed to neutrality with methanol and dried under vacuum. Yield: 25.0 g (100%). ¹H-NMR (500 MHz, [D₂]-D₂O): δ=8.74 (s), 6.48, 6.17, 5.71 (3×dd), 4.87, 2.42, 1.53, (3×s, poly(bis(N-acryloylamino)methane)). 4.65, 4.46, 3.89, 3.84, 3.31, 1.44-1.33 (4×s, 1×m, PVOH) ppm. DSC: T_{G}=55° C., Tₘ=184° C.

### EXAMPLE 7

### Poly(vinyl alcohol-divinylbenzene)/poly(vinyl alcohol)

In a 1000 ml round-bottom flask, 167 ml of a 1% methanolic sodium hydroxide solution is heated to 50° C. in a water bath. To this, a solution of 50 g of poly(vinyl acetate-divinylbenzene)/poly(vinyl acetate) (example 3) in 333 ml of methanol is added dropwise over a period of 30 min. On completion of the addition, the mixture is stirred for 30 min. The white precipitate is filtered, washed to neutrality with methanol and dried under vacuum. Yield: 25.0 g (100%). ¹H-NMR (500 MHz, [D₂]-D₂O): δ=): δ=7.34, 7.25. 7.18, 7.16, 7.05 (aromatic H), 6.63, 5.61, 5.18 (vinylic H), 4.65, 4.46, 3.89, 3.84, 3.31, 1.44-1.33 (4×s, 1×m, PVOH), ppm. DSC: T_{G}=79° C., Tₘ=183° C.

### EXAMPLE 8

### Poly(vinyl alcohol-divinylbenzene)

In a 100 ml round-bottom flask, 16.7 ml of a 1% methanolic sodium hydroxide solution is heated to 50° C. in a water bath. To this, a solution of 5.0 g of poly(vinyl acetate-divinylbenzene) (example 4) in 33.3 ml of methanol is added dropwise over a period of 30 min. On completion of the addition, the mixture is stirred for 30 min. The white precipitate is filtered, washed to neutrality with methanol and dried under vacuum. Yield: 2.5 g (100%). ¹H-NMR (500 MHz, [D₂]-D₂O): δ=7.34, 7.25. 7.18, 7.16, 7.05 (aromatic H), 6.63, 5.61, 5.18 (vinylic H), 4.65, 4.46, 3.89, 3.84, 3.31, 1.44-1.33 (4×s, 1×m, PVOH), ppm. DSC: T_{G}=79° C., Tₘ=181° C.

1-8. (canceled)

9. Poly(vinyl alcohol) copolymers on the basis of poly(vinyl ester) copolymers which are obtained by means of a method comprising the following steps:
A) Radical solution or bulk polymerizing vinyl esters in the presence of a radical generator and in the presence of a radical scavenger.
B) Adding a cross-linking polyalkenyl compound,
C) optionally, processing and isolation of the poly(vinyl ester) copolymers formed,
D) saponificating the poly(vinyl ester)/poly(vinyl ester-polyalkene) mixture prepared in step B) or of the poly(vinyl ester-polyalkene) copolymers isolated under step C) with a base to form the poly(vinyl alcohol)/poly(vinyl alcohol-polyalkene) mixtures or poly(vinyl alcohol-polyalkene) copolymers, respectively, and isolation of the products.

10. Poly(vinyl alcohol) copolymers according to claim 9, wherein the radical generators in step A) are peroxide compounds.

11. Poly(vinyl alcohol) copolymers according to claim 9, wherein the radical generators are used in amounts of 0.05-10 mmol per mole of vinyl acetate.

12. Poly(vinyl alcohol) copolymers according to claim 9, wherein the radical scavengers in step A) are phosphoric acid esters.

13. Poly(vinyl alcohol) copolymers according to claim 9, wherein the radical scavengers are used in amounts of 0.5-10 mol per mole of radical initiator.

14. Poly(vinyl alcohol) copolymers according to claim 9, wherein the polyalkenyl compounds used in step B) are compounds of the formula I: 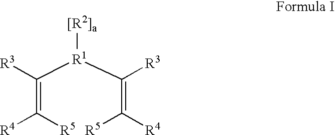
where:
R¹ is a C₆-C₂₀-aryl group, a C₅-C₂₀-heteroaryl group, a C₄-C₂₀-cycloalkyl group, a C₄-C₂₀-heterocycloalkyl group or a C₁-C₂₀-alkyl group, in which one or several not directly neighboring C-atoms may be substituted by an element of the 5 or 6 group of elements and
R² is equal or different, and is hydrogen, oxygen, sulfur or a hydroxy group, a carbamoyl group, an amino group, a carboxy group, a C₁-C₂₀-alkylcarbonyl group, a C₁-C₂₀-alkyloxy group, a C₆-C₂₀-aryloxy group, an imino group, a C₁-C₂₀-alkylimino group, a C₆-C₂₀-alkylimino group, a cyano group, a C₁-C₂₀-alkyl group, a C₆-C₂₀-aryl group, a C₅-C₂₀-heteroaryl group, a C₄-C₂₀-cycloalkyl group, a C₄-C₂₀-heterocycloalkyl, a C₇-C₂₀-alkylaryl group, a C₇-C₃₀-arylalkyl group, a C₂-C₂₀-alkenyl group, a C₂-C₂₀-α-oxyalkenyl, a halogen containing C₁-C₂₀-alkyl group, a C₆-C₂₀-aryl group, a C₇-C₂₀-alkylaryl group, a C₇-C₃₀ arylalkyl group or a C₂-C₂₀-alkenyl group, and
R³, R⁴ and R⁵ are equal or different, and is hydrogen or a C₁-C₂₀-carbon containing group, and
a is a natural integer from 0 to 40.

15. Poly(vinyl alcohol) copolymers according to claim 14, wherein the R¹ is a C₆-C₂₀-aryl group, a C₅-C₂₀-heteroaryl group, a C₄-C₂₀-cycloalkyl group, a C₄-C₂₀-heterocycloalkyl group or a C₁-C₂₀-alkyl group, in which one or several not directly neighboring C-atoms are optionally substituted by nitrogen, phosphorous, oxygen or sulfur.

16. Poly(vinyl alcohol) copolymers according to claim 9, wherein the polyalkenyl compounds used in step B) are used in amounts of 0.0005-1 mol per mole of vinyl acetate.

17. A process to produce Poly(vinyl alcohol) copolymers on the basis of poly(vinyl ester) copolymers which comprises the following steps:
A) Radical solution or bulk polymering of vinyl esters in the presence of a radical generator and in the presence of a radical scavenger.
B) Adding a cross-linking polyalkenyl compound,
C) Optionally, processing and isolation of the poly(vinyl ester) copolymers formed,
D) saponificating the poly(vinyl ester)/poly(vinyl ester-polyalkene) mixture prepared in step B) or of the poly(vinyl ester-polyalkene) copolymers isolated under step C) with a base to form the poly(vinyl alcohol)/poly(vinyl alcohol-polyalkene) mixtures or poly(vinyl alcohol-polyalkene) copolymers, respectively, and isolation of the products.

18. The process according to claim 17, wherein the radical generators in step A) are peroxide compounds.

19. The process according to claim 17, wherein the radical generators are used in amounts of 0.05-10 mmol per mole of vinyl acetate.

20. The process according to claim 17, wherein the radical scavengers in step A) are phosphoric acid esters.

21. The process according to claim 17, wherein the radical scavengers are used in amounts of 0.5-10 mol per mole of radical initiator.

22. The process according to claim 17, wherein the polyalkenyl compounds used in step B) are compounds of the formula I: 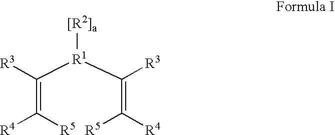
where:
R¹ is a C₆-C₂₀-aryl group, a C₅-C₂₀-heteroaryl group, a C₄-C₂₀-cycloalkyl group, a C₄-C₂₀-heterocycloalkyl group or a C₁-C₂₀-alkyl group, in which one or several not directly neighboring C-atoms may be substituted by an element of the 5 or 6 group of elements and
R² is equal or different, and is hydrogen, oxygen, sulfur or a hydroxy group, a carbamoyl group, an amino group, a carboxy group, a C₁-C₂₀-alkylcarbonyl group, a C₁-C₂₀-alkyloxy group, a C₆-C₂₀-aryloxy group, an imino group, a C₁-C₂₀-alkylimino group, a C₆-C₂₀-alkylimino group, a cyano group, a C₁-C₂₀-alkyl group, a C₆-C₂₀-aryl group, a C₅-C₂₀-heteroaryl group, a C₄-C₂₀-cycloalkyl group, a C₄-C₂₀-heterocycloalkyl, a C₇-C₂₀-alkylaryl group, a C₇-C₃₀-arylalkyl group, a C₂-C₂₀-alkenyl group, a C₂-C₂₀-α-oxyalkenyl, a halogen containing C₁-C₂₀-alkyl group, a C₆-C₂₀-aryl group, a C₇-C₂₀-alkylaryl group, a C₇-C₃₀-arylalkyl group or a C₂-C₂₀-alkenyl group, and
R³, R⁴ and R⁵ are equal or different, and is hydrogen or a C₁-C₂₀-carbon containing group, and
a is a natural integer from 0 to 40.

23. The process according to claim 22, wherein the R¹ is a C₆-C₂₀-aryl group, a C₅-C₂₀-heteroaryl group, a C₄-C₂₀-cycloalkyl group, a C₄-C₂₀-heterocycloalkyl group or a C₁-C₂₀-alkyl group, in which one or several not directly neighboring C-atoms are optionally substituted by nitrogen, phosphorous, oxygen or sulfur.

24. The process according to claim 17, wherein the polyalkenyl compounds used in step B) are used in amounts of 0.0005-1 mol per mole of vinyl acetate.

25. A product which comprises the poly(vinyl alcohol) copolymers according to claim 9.

26. The product as claimed in claim 25, wherein the product is a painting agent, an adhesive, a finishing agent, a coating agent, an additives in papermaking, a lacquer component, a protective colloid, an emulsifier, a binding agent, a protective coating for films, a sizing agent, a metal protection coating, a water-soluble bag and a packaging film, an oil-resistant film, fat-resistant film, a fuel-resistant film, a hose, a seal, a shaving cream additive, a soap additive, a thickening agent in pharmaceutical and cosmetic preparations, a synthetic tear fluid, a water-soluble fiber or sponges, a cement additive, a hydrogel for water treatment or a poly(vinyl alcohol) processable in the melt. _
